(19) United States
(12) Patent Application Publication
(10) Pub. No.: US 2021/0307228 A1
(43) Pub. Date: Oct. 7, 2021

(54) AGRICULTURAL WORKING APPARATUS

(71) Applicant: Kverneland Group Kerteminde AS, Kerteminde (DK)

(72) Inventors: Henrik EGELUND, Kerteminde (DK); Peter WALDEMAR, Kerteminde (DK)

(21) Appl. No.: 17/266,536

(22) PCT Filed: Aug. 7, 2019
(86) PCT No.: PCT/EP2019/071178

§ 371 Date: Feb. 5, 2021

(30) Foreign Application Priority Data
Aug. 7, 2018 (EP) 18187809.1

(51) Int. Cl. A01B 63/111; A01D 78/10; A01D 89/00

(52) U.S. Cl. CPC A01B 63/111; A01D 89/004; A01D 78/1064

(57) ABSTRACT

The invention relates to an agricultural working apparatus for use in forage harvesting and to a corresponding method with tines rotating about an axis A with corresponding tine ends. A device for changing the distance between the tine ends and the ground is also provided, as well as a sensor device for measuring a stubble height. An evaluation unit, in particular a decision support system, is provided to which the sensor device supplies measurement signals for the stubble height and which can determine a position of the tine ends as a function of the measured stubble height. A control device controls the device for changing the distance of the tine ends in order to set the determined position of the tine ends.

### BACKGROUND OF THE INVENTION

The invention relates to an agricultural working apparatus for harvesting forage and a method for adjusting the height of the tine ends of an agricultural working apparatus.

When harvesting forage to produce green forage, undesirable contamination occurs. In particular, the proportion of ash and soil in the forage has a negative effect on the energy content of animal forage, for example cow forage.

On average there are around 80 to 100 grams of ash per kilogram of forage. Even a reduction of 10 grams of forage per kilogram means an energy loss that corresponds to around 100 euros per cow per year. For this reason, there are intense efforts to reduce contamination in the entire production chain Agricultural working apparatuses for forage harvest, such as in particular hayers, swathers, mowers, loading wagons or balers, largely contribute to a corresponding degree of contamination.

The aforementioned working apparatuses for forage harvest all have tines which rotate about an axis A and are largely responsible for the contamination. So far, these tines have been set by the farmer to a predetermined height, that is, they have a predetermined distance from the ground. However, the soil conditions and the stubble height are constantly changing, and therefore contamination is inevitable.

Based on this, the invention has the object of providing an agricultural working apparatus and a method that make it possible to reduce the contamination in the forage and at the same time to work economically and reliably.

This object is achieved according to the invention by the features of claims 1 and 9.

According to the present invention, an agricultural working apparatus is provided for use in forage harvesting having tines rotating about an axis A with corresponding tine ends, and having a device for changing the distance between the tine ends and the ground. The working apparatus also has a sensor device for measuring the stubble height in the field. Lastly, an evaluation unit, in particular a decision support system (DSS), is provided, to which the sensor device can supply measurement signals for the stubble height and which can determine a suitable position, in particular a suitable distance between the tine ends and the ground or the stubble tip, depending on the measured stubble height. A control device controls the device for changing the distance of the tine ends in order to adjust the position, i.e. the distance which was determined, and to bring the tine end into the preferred position.

It has been shown in the context of the present invention that the quality, i.e. the contamination, of the forage depends substantially on how high the stubble is. In particular, it has been found that the ideal position of the tine ends depends substantially on the stubble height. But other results, such as forage losses or capacity, for example, also depend largely on where the tine ends are arranged at different stubble heights. The sensor device according to the invention now measures the stubble height during processing and, as a function of these measured values, an evaluation unit can then determine the correct position of the tine ends, which can then be adjusted.

With the present invention, the contamination with soil and ash can be reduced substantially, since a correct position of the rake tines can always be set.

A so-called decision support system (DSS) can process and specifically evaluate the information supplied. This includes functions such as filtering data, i.e. here parameters and/or weighting of data, i.e. parameters. The system has, for example, evaluation options such as the formation of sums or average calculations, comparisons, etc. Furthermore, such a system allows, for example, the linking of data or parameters with optimisation algorithms. However, it is essential that according to the invention it has now been recognised that the optimal position of the tine ends depends largely on the stubble height and thus varies during the working process.

The decision support system can thus determine an optimised distance of the tine ends using an algorithm.

The decision support system can determine the distance of the tine ends as a function of several parameters, which means that other parameters such as moisture and/or stubble type and/or yield per area, i.e. the yield per area (mass per area—or a proportional value) which is assumed or is determined, for example, via optical sensors and/or sensors for determining the utilisation of the drive train, for example torque sensors, can also be included in the calculation. Moisture is understood here to mean the moisture level of the stubble or the air humidity in an area of the stubble.

For this purpose, the agricultural working apparatus additionally has, for example, at least one further measuring device for parameters, the measuring device(s) then also being connected to the decision support system.

Additionally or alternatively, an input device can also be provided for inputting one or more parameters that are passed to the decision support system so that, for example, parameters such as stubble type etc. can be input.

The working apparatus preferably has a device for measuring the humidity, in particular for measuring the moisture level of the stubble or the air humidity in the area of the stubble. Such a device for measuring the humidity is for example a humidity sensor. To calculate the optimum distance of the tine ends, the decision support system can also use different operating strategies as a basis, which can be stored in the decision support system and which have been determined or calculated empirically. At least one of the following operating strategies can be used:
Distance of the tine ends from the stubble tips depending on the stubble height at maximum capacity. Here, maximum “capacity” means the maximum possible output of the device, in particular the working speed, i.e. the speed of the tines or the transport speed. For a high capacity it is useful, for example, to arrange the tine ends with a small distance to the stubble tips below the stubble tips.

Another operating strategy is-the distance between the tine ends and the stubble tips depending on the stubble height with minimal loss of forage. With this operating strategy, the tine ends should be positioned as low as possible in relation to the ground in order to pile up or pick up the entire cut—but this in turn has a negative impact on capacity and contamination.

Another operating strategy is, for example, the distance between the tine ends and the stubble tips as a function of the stubble height with maximum quality, in particular minimal contamination of the forage. In the case of high quality and low contamination, the tine ends should be positioned as far away from the ground as possible in order to prevent the tine ends from touching the ground—which in turn has a negative effect on the loss.

The farmer can now set priorities and make a corresponding input and select a strategy or weight it differently, or the decision support system determines a compromise range for a stubble height that is suitable for different strategies on the basis of different operating strategies and then determines a suitable position for the tine ends. For example, the system can determine a position of the tine ends for various operating strategies, in which case, for example, an average value is then formed from the tine end positions of the various operating strategies, or certain operating strategies can be specially weighted. Additional parameters can also influence the distance.

The invention is particularly suitable for agricultural working apparatuses, such as hayers, swathers, loading wagons with pick-up rollers or balers with pick-up rollers, all of which have tines rotating about an axis A and are largely responsible for contamination by ash and soil.

Hayers and swathers, for example, have a rotor housing rotating about an axis A, by which the tines are driven, wherein the device for changing the distance between the tine ends and the ground change the position of the rotor housing along the axis A. In addition, for example, a cam track that is arranged in the rotor housing can be height-adjustable within the rotor housing by means of a drive. A swivel angle of the rake tines about the longitudinal axis of each tine arm can be controlled as a function of the rotational position of the tine arm via such a cam track in the rotor housing. By adjusting the height of the cam track, the angle by which the lower end of the tine is pivoted can be significantly influenced in such a way that the distance of the tine end to the ground can also be adjusted.

The tines extending outward from the pick-up roller of a baler or loading wagon rotate about an axis A, with the means for changing the distance of the tine ends to the ground changing the height of the axis A relative to the ground.

The sensor device for measuring the stubble height has at least one distance sensor such that in particular the distance to the tip of the stubble and the distance to the ground can be measured and the stubble height can be determined from the difference.

The sensor device for measuring the stubble height can for example comprise at least one sensor from the following group: optical sensor, ultrasonic sensor, radar sensor, microwave sensor, or angle sensor, in particular by means of laser triangulation.

In the method according to the invention for adjusting the height of the tine ends of an agricultural working apparatus, the following steps are carried out:

measuring the stubble height, sending the measured values to an evaluation unit, in particular a decision support system for determining a suitable position, in particular a suitable distance between the tine ends and the ground or to the stubble tip depending on the measured stubble height, and setting the determined distance of the tine ends.

According to the present invention, measuring the stubble height and setting the distance can be carried out continuously. This means that an ideal setting of the position of the tine ends is always possible, even under changing conditions.

The decision support system determines the distance of the tine ends as a function of several parameters, in particular on the basis of the moisture and/or the stubble type and/or the yield per area. Furthermore, the decision support system can additionally determine the distance of the tine ends on the basis of at least one operating strategy, as was explained in more detail above.

If the distance of the tine ends changes during a revolution about the axis A, a certain distance is used as a basis in the working position of the tines, which is then adjusted accordingly.
It is advantageous if the tine ends are adjusted depending on the stubble height such that the distance from the stubble tip to the tine tip is in a range of 10-50%, in particular 15-30% of the stubble height.

### BRIEF DESCRIPTION OF THE DRAWINGS

The present invention will be described in greater detail with reference to the following figures.

FIG. 1 shows roughly schematically an agricultural working apparatus in the form of a swather according to the present invention.

FIG. 2 shows roughly schematically the essential components according to an embodiment of the present invention.

FIG. 3A shows a graph in which the tine end positions are shown as a function of the stubble height for different cultivation strategies

FIG. 3B shows the stubble height and the corresponding tine end position

FIG. 4A shows a roughly schematic side view of a pick-up roller according to the present invention

FIG. 4B shows roughly schematically a front view of the pick-up roller shown in FIG. 4A

FIG. 5 shows roughly schematically a cam track for guiding a tine lever according to the present invention

### DETAIL DESCRIPTION

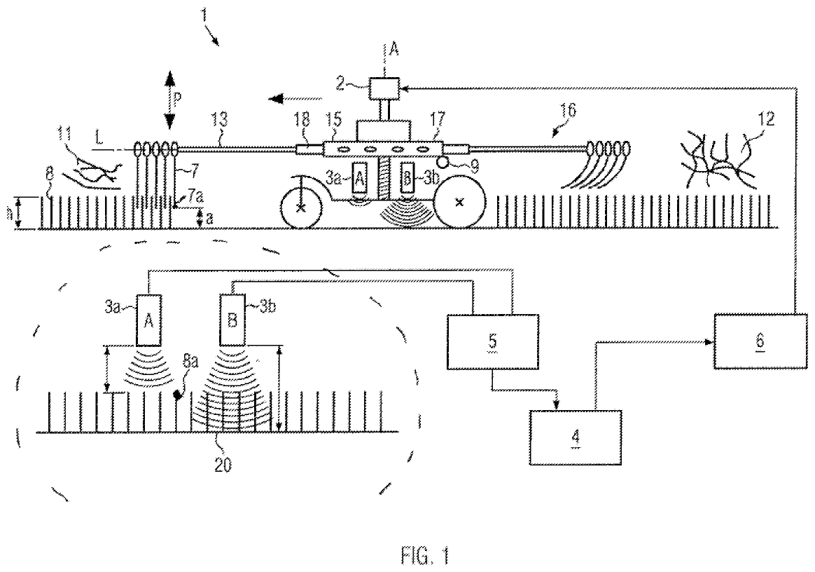

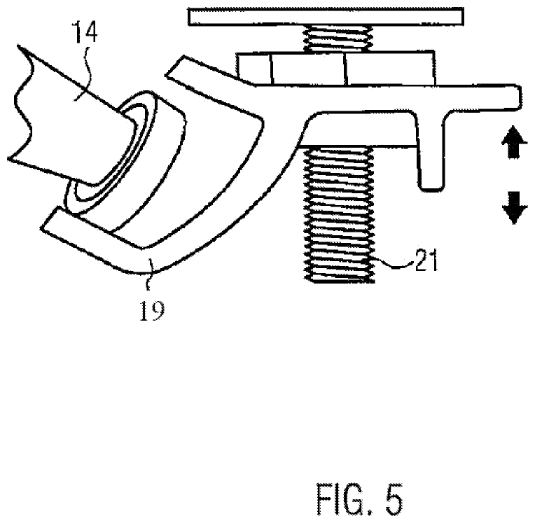

FIG. 1 shows roughly schematically an agricultural working apparatus 1 for use in forage harvesting in the form of a swather 1. The swather 1 has a rotary rake 16 which is attached to a support arm. The swather has a rotor housing 17 which is rotatably mounted about the rotor axis A and is driven in a known manner by a gear, for example a bevel gear, which is mounted in a corresponding gear housing. Tine arms 13 are mounted in openings 18 of the rotor housing 17 that are uniformly distributed around the circumference and are driven by the rotor housing 17. On the tine arms 13, the rake tines 7 are arranged at an angle. At the other end of the tine arms 13, levers 14 are arranged, for example, at an angle, in particular roller levers 14 (see FIG. 5), which rotate on a cam track 19. The pivot angle about the longitudinal axis L of the tine arm 13 can be changed during the revolution about an axis A, that is, the tines 7 can be pivoted into a working position (see left of FIG. 1), i.e. a position in which the rake tines are pivoted down towards the ground and in a position in which the tines are pivoted upwards (see right side of FIG. 1). When the tine arms 13 revolve about the axis A, the rake tines are approximately 36 to 41% of their orbit in the working position. As can be seen from FIG. 1, the swather generates a swath 12 from the cut material 11 which lies on the stubble 8.

The distance a of the tine ends 7a from the floor 20 is adjustable. For this purpose, for example, the height of the rotor housing 17 can be adjusted in height by means of a drive, for example by a height adjustment spindle that is axially supported on both sides in the gear housing and axially supports the chassis axle via the spindle thread. Alternatively, a device 2 consisting of a hydraulic cylinder can also be provided.

The swather 1 according to the invention also has a sensor device 3a, b for measuring the stubble height h of the stubble 8. In particular, the sensor device is designed in such a way that it comprises at least one distance sensor. In this specific embodiment, two distance sensors 3a, 3b are provided which are arranged on the swather and each measure the distance to the stubble tip 8a and the distance to the ground 20. By subtracting the distance to the stubble tip 8a from the distance to the ground 20, the stubble height h results. A corresponding calculation can be carried out in the calculation device 5.

The sensors 3a, 3b are arranged in FIG. 1 below the rotary rake or rotor, but can also be arranged, for example, above, below or behind the rotary rake. In the event that the sensors 3a, b are located above the rotary rake, measurement would then only begin from a certain height, i.e. a distance would be established so that the tine arms would not interfere with the measurement because the measurement only begins below, or measured values that affect the rotating tine arms are masked out or subtracted during the evaluation.

The quality, i.e. the contamination of the forage or the cut material, depends substantially on the position of the tine ends and on how high the stubble 8 is. In particular, the ideal position of the tine ends 7a is substantially dependent on the stubble height h. For this reason, according to the present invention, an evaluation unit 4 determines the optimal position of the tine ends 7a as a function of the stubble height h. The evaluation unit 4 thus determines a suitable distance between the tine ends 7a and the ground 20 or the stubble tip 8a and sends a corresponding signal to the control device 6, which then controls the device 2 as an actuator for changing the distance between the tine ends and the ground. Here, the device 2 adjusts the height of the rotor housing 17, as shown by the arrow P. Since the distance of the tine ends 7a changes during the rotation of the tines around the axis A, a distance at a specific point, in particular in a working position, is used as a basis. Therefore, by monitoring the stubble height h, the rotor height and thus the correct position of the tine ends 7a can be set continuously, even if the stubble height changes. This can significantly reduce the contamination caused by soil and ash, since a correct position of the rake tines can always be set.

The evaluation unit, which is designed in particular as a decision support system 4, enables the working apparatus to simultaneously work economically and reliably. For this purpose, the evaluation unit is preferably designed as a decision support system 4. So-called decision support systems (DSS) can process and specifically evaluate supplied information. This includes functions such as filtering data or parameters and/or weighting data or parameters. The system also has, for example, evaluation options such as the formation of sums or averages, comparisons, etc. Furthermore, a corresponding system enables, for example, the linking of data or parameters with optimisation algorithms so that, for example, an optimal result for the tine end position can be determined on the basis of several parameters. For example, the decision support system 4 can base the evaluation on at least one further parameter in addition to the stubble height.

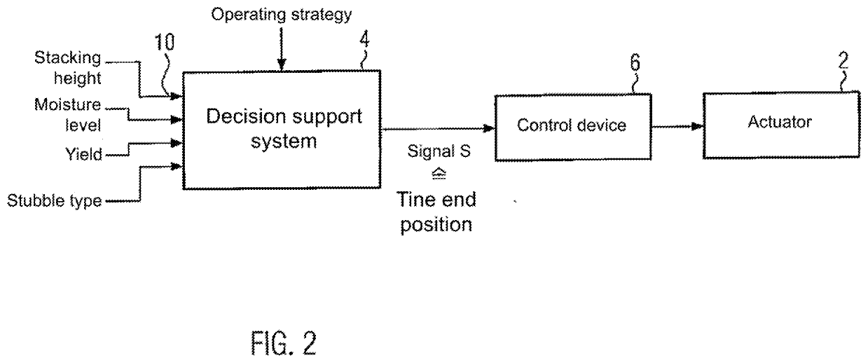

As can be seen in particular from FIG. 2, the moisture level can, for example, be fed to the decision support system 4 as a further parameter or measured value. The moisture level can be measured directly on the swather 9 via a further measuring system 9. For this purpose, a moisture sensor is provided, for example, which can measure the moisture level of the cut material or the air humidity in the area of the stubble 8. The stubble type can be entered as a further parameter, for example grass, alfalfa or field forage. Lastly, the yield can be entered as a parameter or the yield or a value proportional to it can be determined which corresponds to the mass to be processed per area. This value is determined as follows: for example, with an optical sensor and/or one or more sensors to determine the utilisation of the drive train, for example a torque sensor. For parameters that are not measured directly, for example the stubble type, an input device 10 can be provided for inputting one or more parameters that are sent to the decision support system 4. The decision support system then also takes these parameters into account during the evaluation and adjusts the distance a accordingly.

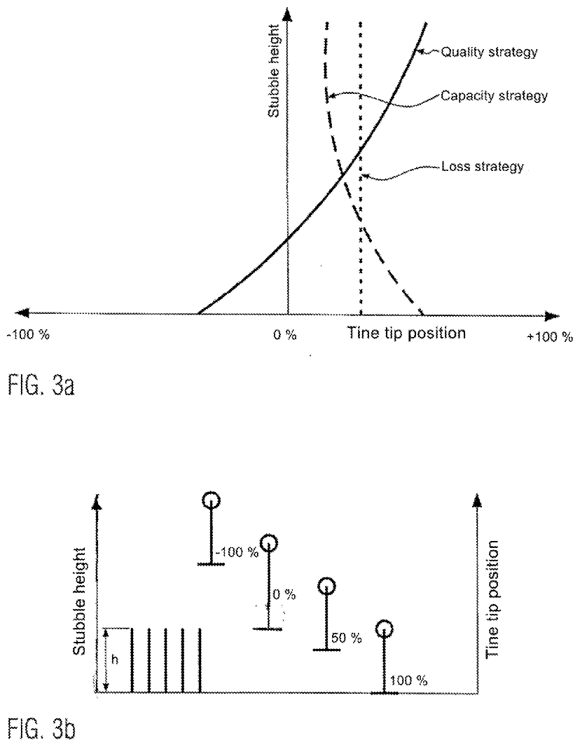

In addition to the calculation of the optimal distance a of the tine ends 7a, the decision support system 4 can also use different operating strategies as a basis; these can be stored in the decision support system and were empirically determined or were calculated beforehand. FIG. 3A shows corresponding operating strategies. In the graph shown in FIG. 3A, the position of the tine ends 8a is plotted as a function of the stubble height. The 0% entry means that the end of the tine is level with the stubble tip 8a. The +100% entry means that the tine end 7a is in contact with the ground 20 and −100% means a corresponding movement (which corresponds to 100% in terms of amount) starting from the stubble tip 8a upwards, as shown in FIG. 3B.

The curve in FIG. 3A represents a quality strategy. This means that the distance between the tine ends and the stubble tip is plotted here as a function of the stubble height with maximum quality, i.e. with minimal contamination of the forage or cut material. As can be seen from FIG. 3A, if the stubble height is very low, the distance from the stubble tip is large, i.e. the relevant tine end 7a is preferably above the stubble tip 8a. With increasing stubble height, the tine end 7b can then also be changed downwards in its optimal position relative to the stubble, up to about half the stubble height (50%). In order to minimise contamination, the tine ends should be positioned as far away from the ground as possible in order to prevent the tine ends from touching the ground, which in turn has a negative effect on the loss, since it is then not ensured that, for example, all of the cut material can be picked up and moved, but rather some cut material remains

The dotted line in FIG. 3A shows the loss strategy, i.e. the distance of the tine ends from the stubble tips as a function of the stubble height with minimal loss, i.e. so that a minimal amount of cut material remains on the ground and, for example, is not heaped into a swath or picked up by the pick-up rollers. With this operating strategy, the tine ends should be positioned so low in relation to the ground that the entire cut can be piled up or picked up—which in turn has a negative impact on capacity and contamination. As shown in FIG. 3A, the tine end position here is in a constant range of about 15-30%, in particular +20%, i.e. 20% lower than the stubble tip in relation to the stubble height.

The dashed line shows the capacity strategy, i.e. the distance between the tine ends and the stubble tips at maximum capacity, i.e. here with maximum possible power of the device, in particular at maximum working speed, i.e. maximum possible speed of the tines and maximum suitable transport speed. As can be seen from FIG. 3A, the distance between the tines and the ground 20 can be reduced with decreasing stubble height or the distance from the stubble tip can increase with decreasing stubble height, here for example it can be moved down to about 50% of the stubble tip.

The farmer can either choose from a strategy and give this priority, or the decision support system 4 calculates a suitable area or a suitable distance a from the different strategies for a stubble height. For example, the system can determine a position of the tine ends for different operating strategies, the mean value then being formed from the distances for the different strategies, for example, it being possible for the different strategies to be weighted differently. This distance can then also be influenced by additional parameters, for example those mentioned above. Because the stubble height can be measured continuously via the sensor device, the ideal distance a can be set continuously. If there is a high moisture level, the distance can be corrected so that the tine ends are moved further down. With different stubble types, such as grass, alfalfa or field forage, the distance a can be corrected accordingly by adjusting the tines further up for alfalfa than for field forage. With light forage, the tine ends are positioned higher up than with heavy forage. If the yield is high, the rake tines are moved further down than if the yield is low.

The sensor device for measuring the stubble height can comprise at least one sensor from the following group: ultrasonic sensor, radar sensor, microwave sensor, etc.

In the embodiment shown in FIG. 1, the height of the rotor housing 17 is adjusted to adjust the position of the tine ends 7a. In addition, the previously described cam track, as can be seen from FIG. 5, can also be adjusted in height. By adjusting a spindle 21 of a spindle motor, for example, the cam track 19 can also be adjusted in the rotor housing. As a result of the height adjustment, the lever 14 also moves, whereby the tine arm 13 rotates about its longitudinal axis L in such a way that the pivot angle of the tines 7 is changed and thus the distance from the ground 20 also changes. Therefore, in this embodiment, both the device 2 for changing the height of the rotor housing 17 is controlled by the control device 6, as well as a drive for the cam track 19, the actual position of the tine end 7a resulting from the sum of the movement of both devices.

It has been found to be particularly advantageous if the tine ends are adjusted depending on the stubble height in such a way that the distance from the stubble tip 8a to the tine tip is in a range of 10-50%, in particular 15-30% of the stubble height.

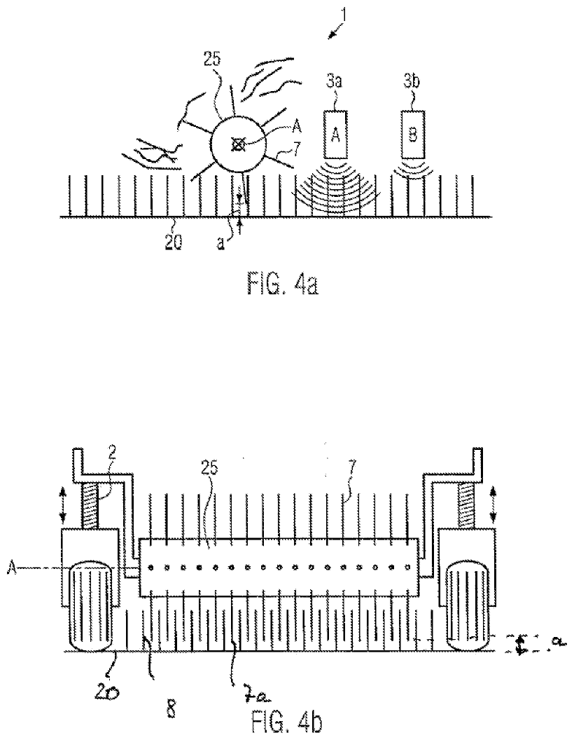

FIGS. 4A and 4B show roughly schematically a further embodiment according to the present invention, which substantially corresponds to the first embodiment, but here a pick-up roller with revolving tines 7 is used. Here, the tines 7 also rotate about the axis A, which, however, is oriented substantially horizontally here. As in the previous exemplary embodiment, the evaluation unit 4, in particular the decision support system 4, can determine the ideal distance a from the ground 20 and can then control the device 2 for changing the distance between the tine ends and the ground 20 or the stubble tips via the control device 6. The device 2 for changing the distance is here, for example, a hydraulic cylinder which changes the height of the shaft or axle A of the pick-up roller 25.

In the method according to the invention, different operating strategies can be programmed into a decision support system 4 in advance, as shown in FIG. 3A. In addition, further parameters can be entered, for example by the farmer, via an input device 10 (see FIG. 2). Furthermore, the stubble height can be measured during operation using the measuring devices 3a, 3b and, if necessary, calculated using the calculation device 5. However, at least one further measuring device 9 can also be provided, for example for measuring the moisture level, with corresponding measured values also being fed into the decision support system 4. The measurement of the stubble height and possibly also the measurement of further measured values or parameters can take place continuously, so that the decision support system 4 can continuously determine a suitable position of the tine ends 7a and can transmit a corresponding signal to the control 6, which in turn controls the device 2 for changing the distance of the tine ends to the ground, for example to raise or lower the rotor housing 15 or the shaft or axle A of the pick-up roller. Therefore, the invention makes it possible on the one hand to reduce contamination in the forage, but at the same time allows an economical and reliable mode of operation.

Even if these cannot be named here in detail, further parameters can be taken into account to determine the suitable position.

According to a preferred embodiment, the parameters used to determine the position of the tine tips, in particular the measurement parameters, are transmitted to a mobile device, for example a cell phone or tablet, for example via Bluetooth or WLAN.

All measured or entered parameters can also be transferred to external programs for further processing and then, for example, geo-referenced data, including GPS data, can be used for yield mapping.

1. Agricultural working apparatus (1) for use in forage harvesting, having tines (7) rotating about an axis (A) with corresponding tine ends (7a),
a device (2) for changing the distance (a) of the tine ends (7a) to the ground (20),
a sensor device (3a, 3b) for measuring a stubble height (h),
an evaluation unit (4), in particular a decision support system (4) to which the sensor device (3a, b) supplies measurement signals for the stubble height, and which, depending on the measured stubble height, can determine a suitable position of the tine ends, in particular the distance from the tine ends to the ground or to the stubble tip (8a), and
a control device (6) which controls the device (2) for changing the distance of the tine ends (7a) in order to set the determined position.

2. Agricultural working apparatus according to claim 1, wherein the decision support system (4) can determine the distance of the tine ends by means of an algorithm.

3. Agricultural working apparatus according to claim 1, wherein the decision support system (4) can determine the distance of the tine ends as a function of several parameters, in particular moisture and/or stubble type and/or yield per area.

4. Agricultural working apparatus according to claim 1, wherein the agricultural working apparatus (1) has at least one additional measuring device (9) for parameters, the measuring device(s) being connected to the decision support system (4) and/or furthermore
an input device (10) is provided for entering one or more parameters,
wherein the working apparatus (1) preferably has a device for measuring the humidity, in particular the moisture level of the stubble or air humidity in the area of the stubble.

5. Agricultural working apparatus (1) according to claim 1, wherein the decision support system (4) additionally determines the distance of the tine ends on the basis of at least one operating strategy that is stored in the decision support system (4), wherein, in particular, at least one of the following working strategies can be used:
distance of the tine ends (7a) from the stubble tips (8a) depending on the stubble height at maximum capacity and/or
distance of the tine ends (7a) from the stubble tips (8a) depending on the stubble height with minimal loss and/or
distance of the tine ends (7a) from the stubble tips (8a) depending on the stubble height with maximum quality, in particular minimal contamination of the forage.

6. Agricultural working apparatus according to claim 1, wherein the agricultural working apparatus (1) is a hayer, swather, loading wagon with pick-up roller or baler with pick-up roller, wherein
the hayer and swather have a rotor housing (17) rotating about an axis (A), by which the tines (7) are driven, wherein the device (2) for changing the distance of the tine ends (7a) to the ground (20) can change the position of the rotor housing (17) along the axis (A) and preferably in addition a cam track (19) within the rotor housing (17) can be changed or
the tines (7), which extend outward from the pick-up roller, revolve about an axis (A), wherein the device (2) for changing the distance of the tine ends to the ground (20) changes the height of the axis (A) relative to the ground (20).

7. Agricultural working apparatus according to claim 1, wherein the sensor device (3a, b) has at least one distance sensor, in particular such that the distance to the stubble tip (8a) and the distance to the ground (20) can be measured and the stubble height (h) can be determined from the difference.

8. Agricultural working apparatus according to claim 1, wherein the sensor device (3a, b) for measuring the stubble height (h) can comprise at least one sensor from the following group: ultrasonic sensor, radar sensor, microwave sensor.

9. Method for adjusting the height of the tine ends (7a) of an agricultural working apparatus (1), in particular according to claim 1, with the following steps:
measuring the stubble height (h),
transmitting the measured values to an evaluation unit, in particular a decision support system (4), to determine a suitable position of the tine ends (7a), in particular a distance of the tine ends to the ground or to the stubble tip depending on the measured stubble height,
setting the determined position of the tine ends.

10. Method according to claim 9, wherein the stubble height is measured and the distance is set continuously.

11. Method according to claim 9 wherein the decision support system (4) determines the distance of the tine ends as a function of several parameters, in particular on the basis of the moisture and/or the stubble type and/or the yield per area.

12. Method according to claim 9, wherein the decision support system (4) additionally determines the distance of the tine ends (7a) on the basis of at least one operating strategy that is stored in the decision support system, wherein in particular at least one of the following processing strategies can be used
distance between the tine ends (7a) and the stubble tips (8) depends on the stubble height at maximum capacity and/or
distance of the tine ends from the stubble tips depending on the stubble height with minimal loss and/or
distance of the tine ends from the stubble tips as a function of the stubble height with maximum quality, in particular minimal contamination of the forage.

13. Method according to claim 9, wherein if the distance of the tine ends (7a) changes during a revolution about the axis (A), a distance at a certain point, in particular in a working position of the tines, is used as the basis.

14. Agricultural working apparatus (1) according to claim 1, wherein a calculation device (5) is also provided for calculating the stubble height from the measured value or the measured values of the sensor device (3a, b).

15. Method according to claim 9, wherein the tine ends are adjusted depending on the stubble height in such a way that the distance from the stubble tip (8a) to the tine tip (7a) is in a range of 10-50%, in particular 15-30% of the stubble height.

16. Method according to claim 9, wherein the parameters used to determine the position of the tine tips, in particular the measurement parameters, are transmitted to a mobile device, in particular a cell phone or tablet, in particular via Bluetooth or WLAN.
